(19) United States
(12) Patent Application Publication
(10) Pub. No.: US 2023/0162138 A1
(43) Pub. Date: May 25, 2023

(54) SERVER AND CONTROL METHOD THEREOF

(71) Applicants: HYUNDAI MOTOR COMPANY, Seoul (KR); KIA CORPORATION, Seoul (KR)

(72) Inventor: Taeho LEE, Seoul (KR)

(73) Assignees: Hyundai Motor Company, Seoul (KR); KIA CORPORATION, Seoul (KR)

(21) Appl. No.: 17/871,158

(22) Filed: Jul. 22, 2022

(30) Foreign Application Priority Data
Nov. 22, 2021 (KR) 10-2021-0160971

(51) Int. Cl. G06Q 10/08; G06Q 10/04; G06Q 50/30

(52) U.S. Cl. CPC G06Q 10/08355; G06Q 10/04; G06Q 10/0833; G06Q 50/30

(57) ABSTRACT

A server that determines a delivery route of a package includes: a communicator performing communication with terminals of a sender, a deliverer and a receiver; and a controller configured to determine a plurality of delivery plans corresponding to estimated locations of the receiver at respective time points, based on location information received from the terminals of the sender, the deliverer and the receiver, shipment readiness time information received from the sender's terminal, and information about the estimated locations received from the receiver's terminal, determine a final delivery plan among the plurality of delivery plans based on at least one of a delivery time required, a safety of a receipt location, or means of transport of the deliverer, and control the communicator to transmit the final delivery plan to the terminals of the sender, the deliverer and the receiver.

### CROSS-REFERENCE TO RELATED APPLICATION

This application is based on and claims the benefit of priority to Korean Patent Application No. 10-2021-0160971, filed on Nov. 22, 2021 in the Korean Intellectual Property Office, the disclosure of which is incorporated herein by reference.

### TECHNICAL FIELD

The disclosure relates to a server and a control method thereof that determines a package delivery plan.

### BACKGROUND ART

Recently, due to the development of Internet commerce, people may purchase goods on-line and receive the goods from a delivery person without directly going to a store.

In general, for delivery, a shipping origin and a destination are fixed, and a delivery person who belongs to a corresponding origin or destination handles delivery, thereby establishing a systematic delivery system.

However, because a shipping origin, a destination and delivery person may not be adaptively changed, delivery efficiency is lowered. For example, a receiver may only receive a package from a specific location, and a package is delivered by a specific delivery person, leading to an inefficient delivery route or delivery time.

### SUMMARY

An aspect of the disclosure provides a server and a control method thereof that may determine an optimized delivery plan based on an optimal delivery route and delivery person by considering locations of a sender, a delivery person and a receiver, when a location of the receiver changes with time.

According to an aspect of the disclosure, there is provided a server that determines a delivery route of a package, the server including: a communicator configured to perform communication with terminal of each of a sender, a deliverer and a receiver; and a controller configured to determine a plurality of delivery plans corresponding to estimated locations of the receiver at the respective time points, based on location information received from the terminal of each of the sender, the deliverer and the receiver, shipment readiness time information received from the terminal of the sender, and information about the estimated locations at the respective time points received from the terminal of the receiver, determine a final delivery plan among the plurality of delivery plans based on at least one of a delivery time required, a safety of a receipt location, or means of transport of the deliverer, and control the communicator to transmit the final delivery plan to the terminal of each of the sender, the deliverer and the receiver, wherein each of the plurality of delivery plans includes information about a delivery route between a location of the sender and a corresponding estimated location of the receiver and information about a deliverer who performs a delivery for each section among a plurality of sections included in the delivery route.

The controller is configured to determine a delivery plan having a minimum delivery time among the plurality of delivery plans, as the final delivery plan.

The controller is configured to determine a delivery plan having an expected receipt location with a highest safety as the receipt location among the estimated locations of the receiver at the respective time points, among the plurality of delivery plans, as the final delivery plan.

The controller is configured to determine a delivery plan having a deliverer who uses a preferred means of transport as the deliverer to perform the delivery, based on information about the preferred means of transport received from the terminal of the receiver, among the plurality of delivery plans, as the final delivery plan.

When information about a changed estimated location at a time point is received from the terminal of the receiver, the controller is configured to update the final delivery plan based on the changed estimated location of the receiver at the time point.

When it is determined that circumstances of a deliverer to perform the delivery in the final delivery plan are changed based on state information received from a terminal of the deliverer, the controller is configured to update the final delivery plan based on the changed circumstances of the deliverer.

The controller is configured to determine the plurality of delivery plans by determining a deliverer to perform a delivery plan, based on at least one evaluation item of a degree of freedom from traffic conditions, a preference, a degree of freedom from weather conditions, a delivery success rate according to characteristics of the package, whether manned or unmanned, ease of delivery, a delivery cost, a total delivery time, or a preferred means of transport of the receiver.

The controller is configured to determine an evaluation score for each deliverer by summing up scores of each of the at least one evaluation item, and determine a deliverer having a highest evaluation score as the deliverer to perform the delivery plan.

According to an aspect of the disclosure, there is provided a control method of a server including a communicator, the control method including: determining a plurality of delivery plans corresponding to estimated locations of a receiver at the respective time points, based on location information received from terminal of each of a sender, a deliverer and the receiver, shipment readiness time information received from the terminal of the sender, and information about the estimated locations at the respective time points received from the terminal of the receiver; determining a final delivery plan among the plurality of delivery plans based on at least one of a delivery time required, a safety of a receipt location, or means of transport of the deliverer; and controlling the communicator to transmit the final delivery plan to the terminal of each of the sender, the deliverer and the receiver, wherein each of the plurality of delivery plans includes information about a delivery route between a location of the sender and a corresponding estimated location of the receiver and information about a deliverer who performs a delivery for each section among a plurality of sections included in the delivery route.

The determining of the final delivery plan includes determining a delivery plan having a minimum delivery time among the plurality of delivery plans, as the final delivery plan.

The determining of the final delivery plan includes determining a delivery plan having an expected receipt location with a highest safety as the receipt location among the estimated locations of the receiver at the respective time points, among the plurality of delivery plans, as the final delivery plan.

The determining of the final delivery plan includes determining a delivery plan having a deliverer who uses a preferred means of transport as the deliverer to perform the delivery, based on information about the preferred means of transport received from the terminal of the receiver, among the plurality of delivery plans, as the final delivery plan.

The control method further includes, when information about a changed estimated location at a time point is received from the terminal of the receiver, updating the final delivery plan based on the changed estimated location of the receiver at the time point.

The control method further includes, when it is determined that circumstances of a deliverer to perform the delivery in the final delivery plan are changed based on state information received from the terminal of the deliverer, updating the final delivery plan based on the changed circumstances of the deliverer.

The determining of the plurality of delivery plans includes determining the plurality of delivery plans by determining a deliverer to perform a delivery plan, based on at least one evaluation item of a degree of freedom from traffic conditions, a preference, a degree of freedom from weather conditions, a delivery success rate according to characteristics of a package, whether manned or unmanned, ease of delivery, a delivery cost, a total delivery time, or a preferred means of transport of the receiver.

The determining of the plurality of delivery plans includes determining an evaluation score for each deliverer by summing up scores of each of the at least one evaluation item, and determining a deliverer having a highest evaluation score as the deliverer to perform the delivery plan.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a delivery plan determination system according to an embodiment;

FIG. 2 is a control block diagram illustrating the server 100 according to an embodiment;

FIG. 3 is a signal flow graph illustrating operations of determining a final delivery plan by a server according to an embodiment;

FIG. 4 is a diagram illustrating an example where a server determines a deliverer to perform a delivery plan according to an embodiment;

FIG. 5 is a diagram illustrating an example where a server determines a plurality of delivery plans according to an embodiment;

FIG. 6 is a diagram illustrating an example where a server determines a final delivery plan among a plurality of delivery plans according to an embodiment;

FIG. 7 is a diagram illustrating an example where a server updates a final delivery plan based on a change in estimated location of a receiver according to an embodiment;

FIG. 8 is a diagram illustrating an example where a server updates a final delivery plan based on a change in circumstances of a deliverer according to an embodiment; and

FIG. 9 is a flowchart illustrating operations of determining a final delivery plan in a control method of a server according to an embodiment.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but do not preclude the presence or addition of one or more other features, integers, steps, operations, elements, components, and/or groups thereof.

It is to be understood that the singular forms are intended to include the plural forms as well, unless the context clearly dictates otherwise.

The terms such as “˜part”, “˜device”, “˜member”, “˜module”, “˜block”, and the like may refer to a unit for processing at least one function or act. For example, the terms may refer to at least process processed by at least one hardware, such as field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, an operation principle and embodiments will be described in detail with reference to the accompanying drawings.

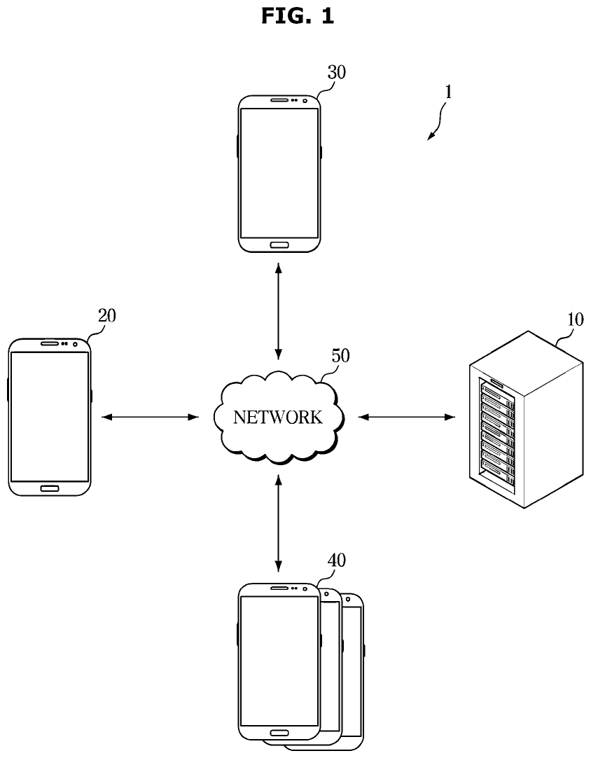

FIG. 1 illustrates a delivery plan determination system according to an embodiment.

Referring to FIG. 1, a delivery plan determination system 1 according to an embodiment may include a server 10 that determines an optimized delivery plan, a receiver's terminal 20, a sender's terminal 30, and a deliverer's terminal 40.

Each of the server 10, the receiver's terminal 20, the sender's terminal 30, and the deliverer's terminal 40 may perform communication through a network 50.

Here, the terminals 20, 30 and 40 may be an electronic device like a smartphone, and capable of inputting data and outputting a processing result by being connected to the server 10 through the network.

In this instance, the receiver refers to a person who orders goods and receives the delivered goods, and the sender refers to a person who sends the goods when receiving an order for the goods.

Also, the deliverer corresponds to a subject that delivers the goods, i.e., a package, and may be a delivery person using means of transport (e.g., a vehicle or motorcycle) or be a means of transport (e.g., a drone) itself.

According to an embodiment, the server 10 may determine an optimized delivery plan to deliver a package from the sender to the receiver based on information received from each of the receiver's terminal 20, the sender's terminal 30, and the deliverer's terminal 40. Also, the server 10 may transmit the determined optimized delivery plan to each of the receiver's terminal 20, the sender's terminal 30, and the deliverer's terminal 40.

In this instance, the optimized delivery plan may include information about a delivery route between a location of the sender and an estimated location of the receiver and information about the deliverer who will perform delivery for each section among a plurality of sections included in the delivery route.

Determining the optimized delivery plan is described in detail later.

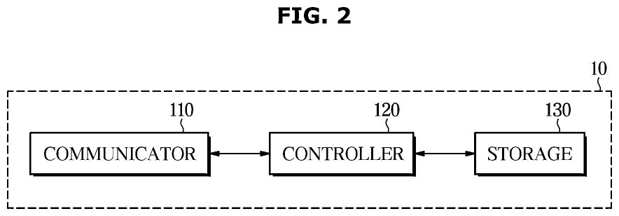

FIG. 2 is a control block diagram illustrating the server 100 according to an embodiment.

Referring to FIG. 2, the server 10 according to an embodiment includes a communicator 110, a controller 120 and a storage 130. The communicator 110 performs communication with the external terminals 20, 30 and 40, and the controller 120 determines an optimized delivery plan based on information received from the external terminals 20, 30 and 40. The storage 130 stores various information required for determining the optimized delivery plan.

According to an embodiment, the communicator 110 may be connected to the network 50 by wire or wirelessly, and transmit and receive data with the external terminals 20, 30 and 40 through the network 50.

To this end, the communicator 110 may be provided as a known type of communication module (e.g., a transceiver, etc.), and the type is not limited.

According to an embodiment, the controller 120 may determine the optimized delivery plan based on data received from the external terminals 20, 30 and 40 through the communicator 110, and control the communicator 110 to transmit the optimized delivery plan to the external terminals 20, 30 and 40.

Specifically, the controller 120 may determine a plurality of delivery plans corresponding to estimated locations of a receiver at respective time points, based on location information received from each of the receiver's terminal 20, the sender's terminal 30, and the deliverer's terminal 40, shipment readiness time information received from the sender's terminal 30, and information about the estimated locations at the respective time points received from the receiver's terminal 40.

In this instance, each of the plurality of delivery plans may include information about a delivery route between a location of the sender and a corresponding estimated location of the receiver and information about a deliverer who will perform a delivery for each section among a plurality of sections included in the delivery route.

Also, the controller 120 may determine the plurality of delivery plans by determining the deliverer to perform the delivery plan, based on at least one evaluation item of a degree of freedom from traffic conditions, a preference, a degree of freedom from weather conditions, a delivery success rate according to characteristics of a package, whether manned or unmanned, ease of delivery, a delivery cost, a total delivery time, or a preferred means of transport of the receiver.

In this instance, the controller 120 may determine an evaluation score for each deliverer by summing up scores of each of the at least one evaluation item, and determine a deliverer having a highest evaluation score as the deliverer to perform the delivery.

The controller 120 may determine a final delivery plan among the plurality of delivery plans, based on at least one of a delivery time required, a safety of a receipt location, or means of transport of the deliverer, and control the communicator 110 to transmit the final delivery plan to each of the receiver's terminal 20, the sender's terminal 30, and the deliverer's terminal 40.

For example, the controller 120 may determine a delivery plan having a minimum delivery time among the plurality of delivery plans, as the final delivery plan.

Also, the controller 120 may determine a delivery plan having an expected receipt location with a highest safety as the receipt location among the estimated locations of the receiver at the respective time points, among the plurality of delivery plans, as the final delivery plan.

In addition, the controller 120 may determine a delivery plan having a deliverer who uses a preferred means of transport as the deliverer to perform the delivery, based on information about the preferred means of transport received from the receiver's terminal 20, among the plurality of delivery plans, as the final delivery plan.

Further, according to an embodiment, the controller 120 may adaptively update the final delivery plan after determining the final delivery plan.

For instance, when information about a changed estimated location at a time point is received from the receiver's terminal 20, the controller 120 may update the final delivery plan based on the changed estimated location of the receiver at the time point.

Also, when it is determined that circumstances of a deliverer to perform the delivery in the final delivery plan are changed based on state information received from the deliverer's terminal 40, the controller 120 may update the final delivery plan based on the changed circumstances of the deliverer.

The controller 120 may include at least one non-transitory memory storing a program for performing the aforementioned operations and operations described below, and at least one processor for implementing a stored program. When a plurality of memories and processors are provided, the plurality of memories and processors may be integrated into one chip or provided in physically separated locations.

According to an embodiment, the storage 130 may store various information to determine the optimized delivery plan. For example, the storage 130 may store information received from each of the external terminals 20, 30 and 40 and store an algorithm for determining the optimized delivery plan.

To this end, the storage 130 may be provided as a known type of storage medium, and the type is not limited.

Configurations of the server 10 have been described above. Hereinafter, determining an optimized delivery plan by the server 10 is described in detail.

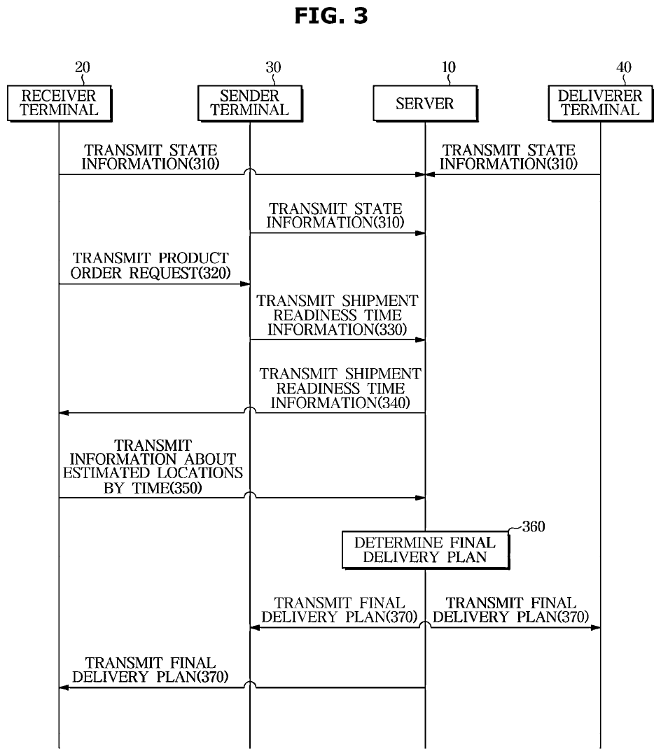

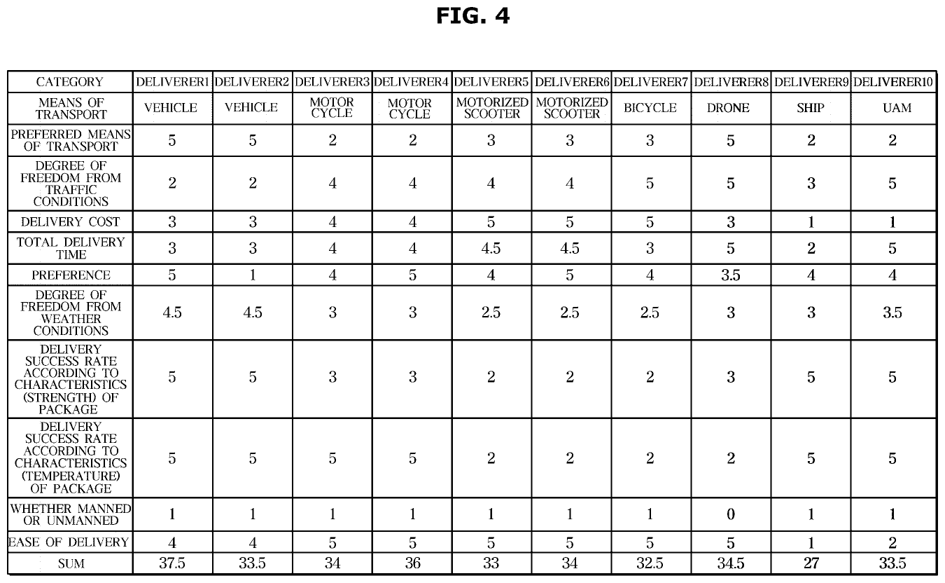

FIG. 3 is a signal flow graph illustrating operations of determining a final delivery plan by the server 10 according to an embodiment, and FIG. 4 is a diagram illustrating an example where the server 10 determines a deliverer who performs a delivery plan according to an embodiment.

Referring to FIG. 3, according to an embodiment, the receiver's terminal (receiver terminal) 20, the sender's terminal (sender terminal) 30 and the deliverer's terminal (deliverer terminal) 40 may transmit state information to the server 10 (310).

In this instance, the state information may include location information, information about whether to move, information about a destination, and the like.

Also, the transmission of the state information may be repeated at preset time intervals or in real time.

According to an embodiment, the receiver terminal 20 may transmit a product order request to the sender terminal 30 based on a user input (320).

When the product order request is received, the sender terminal 30 may transmit information about a time when a shipment is fully ready (shipment readiness time information) to the server 10 (330).

In this instance, the server 10 may transmit the shipment readiness time information to the receiver terminal 20 (340). The receiver terminal 20 may transmit information about estimated locations at respective time points to the server 10 (350).

In this instance, the information about estimated locations at respective time points corresponds to information obtained by determining the estimated locations at multiple time points in a situation where the receiver is moving and converting it into data. The information about estimated locations at the respective time points may indicate estimated locations of the moving receiver at multiple time points from an initial time point (e.g., an estimated location 10 minutes later, an estimated location 20 minutes later, an estimated location 25 minutes later, etc.).

According to an embodiment, the server 10 may determine a final delivery plan (360), and transmit the final delivery plan to the receiver terminal 20, the sender terminal 30 and the deliverer terminal 40 (370).

In this instance, the server 10 may determine a plurality of delivery plans corresponding to the estimated locations of the receiver at the respective time points, based on location information received from each of the receiver terminal 20, the sender terminal 30 and the deliverer terminal 40, the shipment readiness time information received from the sender terminal 30, and the information about estimated locations at the respective time points received from the receiver terminal 20.

In this instance, each of the plurality of delivery plans may include information about a delivery route between a location of the sender and a corresponding estimated location of the receiver and information about a deliverer who will perform delivery for each section among a plurality of sections included in the delivery route.

Also, as shown in FIG. 4, the server 10 may determine the plurality of delivery plans by determining a deliverer to perform the delivery plan, based on at least one evaluation item of a degree of freedom from traffic conditions, a preference, a degree of freedom from weather conditions, a delivery success rate according to characteristics (e.g., strength, temperature) of a package, whether manned or unmanned, ease of delivery, a delivery cost, a total delivery time, or a preferred means of transport of the receiver.

In this instance, the server 10 may determine an evaluation score for each deliverer by summing up scores of each of the at least one evaluation item, and determine a deliverer having a highest evaluation score as the deliverer to perform the delivery plan. The score of each of the evaluation items may be evaluated and stored for each deliverer, and be assigned based on a delivery history, senders' reviews, receivers' reviews, a setting of the receiver's preference, and the like.

For example, as shown in FIG. 4, the server 10 may determine a delivery plan that includes a deliverer 1, a deliverer 4 and a deliverer 8 having high evaluation scores as the deliverer to perform a delivery plan.

The server 10 may determine the deliverer with a highest evaluation score as the deliverer to perform the delivery plan, and also determine a plurality of delivery plans corresponding to estimated locations of the receiver at the respective time points, based on a location of the determined deliverer, a location and shipment readiness time of the sender, and the estimated locations of the receiver.

The server 10 may determine the final delivery plan among the plurality of delivery plans, based on at least one of a delivery time required, a safety of a receipt location, or means of transport of the deliverer, and control the communicator 110 to transmit the final delivery plan to each of the receiver terminal 20, the sender terminal 30, and the deliverer terminal 40.

Hereinafter, an example where the server 10 determines the final delivery plan is described in detail.

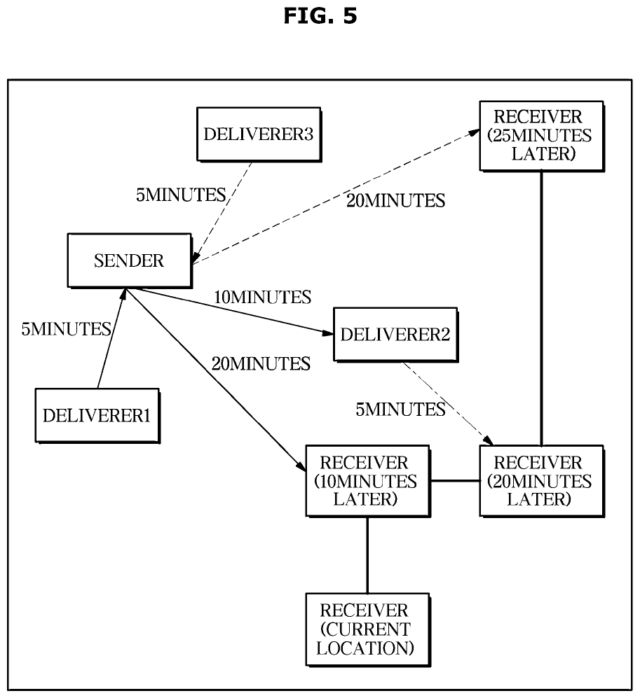

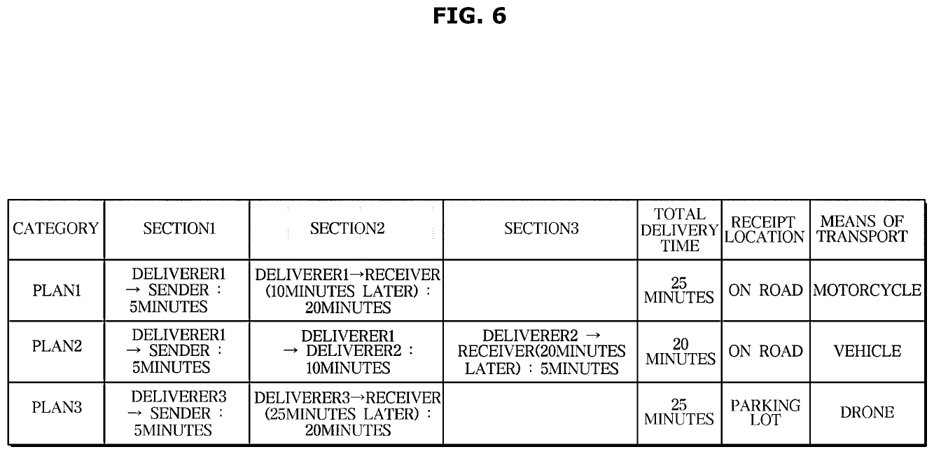

FIG. 5 is a diagram illustrating an example where the server 10 determines a plurality of delivery plans according to an embodiment. FIG. 6 is a diagram illustrating an example where the server 10 determines a final delivery plan among a plurality of delivery plans according to an embodiment.

Referring to FIGS. 5 and 6, according to an embodiment, the server 10 may determine a plurality of delivery plans corresponding to estimated locations of the receiver at respective time points, based on location information received from each of the receiver terminal 20, the sender terminal 30 and the deliverer terminal 40, shipment readiness time information received from the sender terminal 30, and information about the estimated locations at the respective time points received from the receiver terminal 20.

That is, the server 10 may determine a delivery route and a deliverer who will perform a delivery for each section among a plurality of sections included in the delivery route, based on the location information received from each of the receiver terminal 20, the sender terminal 30 and the deliverer terminal 40, the shipment readiness time information received from the sender terminal 30, and the information about the estimated locations at the respective time points received from the receiver terminal 20. Here, the delivery route is a route for a deliverer to reach a location of the sender at the shipment readiness time, pick up a package and then deliver the package to location of the receiver.

For example, as shown in FIGS. 5 and 6, the server 10 may determine, as a first delivery plan, a delivery route where a deliverer 1 reaches a location of the sender (Section 1) and then moves to an estimated location of the receiver 10 minutes later from an initial location of the receiver (Section 2). Also, the server 10 may determine, as a second delivery plan, a delivery route where the deliverer 1 reaches the location of the sender (Section 1) and delivers the package to a deliverer 2 (Section 2), and then the deliverer 2 moves to an estimated location of the receiver 20 minutes later from the initial location of the receiver (Section 3). Also, the server 10 may determine, as a third delivery plan, a delivery route where a deliverer 3 reaches the location of the sender (Section 1) and then moves to an estimated location of the receiver 25 minutes later from the initial location of the receiver (Section 2).

The server 10 may determine a final delivery plan among the plurality of delivery plans, based on at least one of a delivery time required, a safety of a receipt location, or means of transport of the deliverer, and control the communicator 110 to transmit the final delivery plan to each of the receiver's terminal 20, the sender's terminal 30, and the deliverer's terminal 40.

According to embodiments, the server 10 may determine a delivery plan having a minimum delivery time among the plurality of delivery plans, as the final delivery plan.

In this instance, based on location information of each subject, the server 10 may determine a travel time of deliverer between the sender and the deliverer, a travel time of deliverer between the deliverer and another deliverer, and a travel time of deliverer between the deliverer and an estimated location of the receiver. Also, the server 10 may determine a total delivery time as well as a travel time for each section of the delivery plan.

For example, as shown in FIG. 6, when the first delivery plan, the second delivery plan and the third delivery plan are determined, the server 10 may determine the second delivery plan that has a shortest delivery time among the plurality of delivery plans, as the final delivery plan.

Also, according to embodiments, the server 10 may determine a delivery plan having an expected receipt location with a highest safety as a receipt location, among the estimated locations of the receiver at the respective time points, among the plurality of delivery plans, as the final delivery plan.

For instance, as shown in FIG. 6, when the first delivery plan, the second delivery plan and the third delivery plan are determined, the server 10 may determine, as the final delivery plan, the third delivery plan that has a parking lot with relatively higher safety for receipt as the expected receipt location than the first and second delivery plans.

In addition, according to embodiments, the server 10 may determine a delivery plan having a deliverer who uses a preferred means of transport as the deliverer to perform the delivery, based on information about the preferred means of transport received from the receiver's terminal 20, among the plurality of delivery plans, as the final delivery plan.

For example, as shown in FIG. 6, when the first delivery plan, the second delivery plan and the third delivery plan are determined and a preferred means of transport set by the receiver is a motorcycle, the server 10 may determine, as the final delivery plan, the first delivery plan where a deliverer 1 who uses a motorcycle as means of transport perform delivery.

Determining the final delivery plan by the server 10 has been described above. Hereinafter, updating the final delivery plan is described in detail.

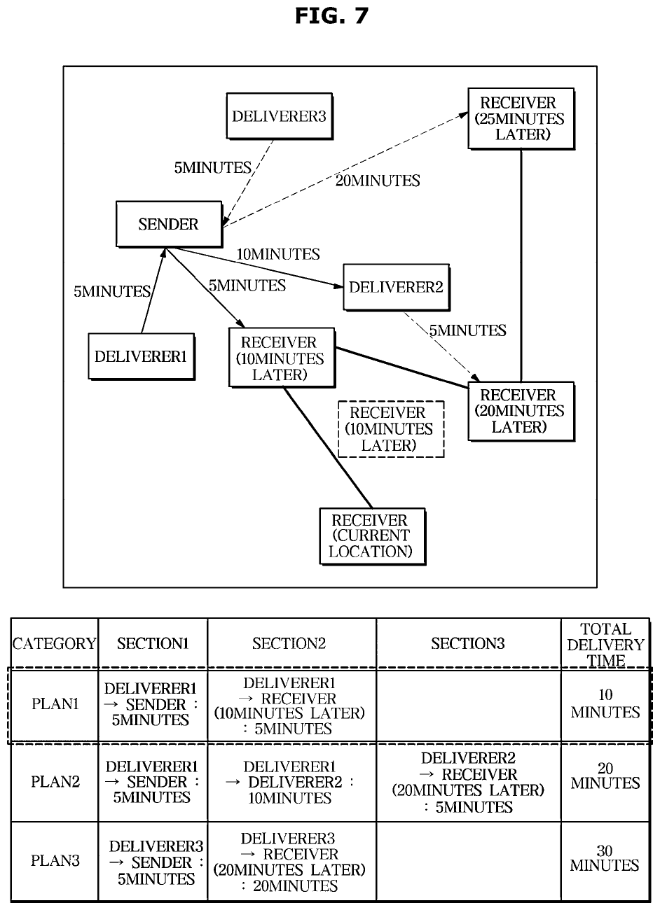

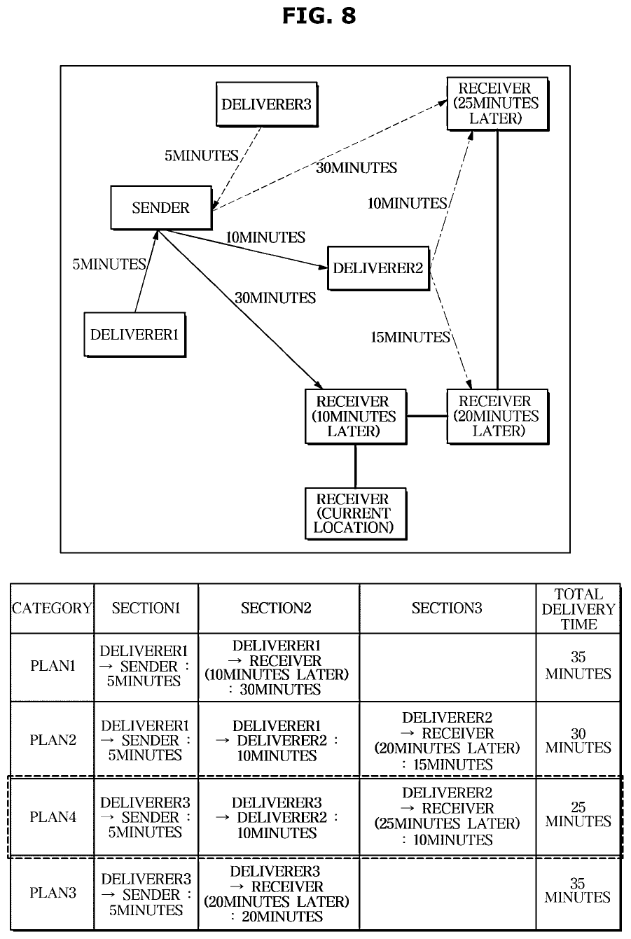

FIG. 7 is a diagram illustrating an example where the server 10 updates a final delivery plan based on a change in estimated location of a receiver according to an embodiment. FIG. 8 is a diagram illustrating an example where the server 10 updates a final delivery plan based on a change in circumstances of a deliverer according to an embodiment.

Referring to FIGS. 7 and 8, according to an embodiment, the server 10 may adaptively update a final delivery plan after determining the final delivery plan.

According to embodiments, when information about a changed estimated location at a time point is received from the receiver's terminal 20, the server 10 may update the final delivery plan, based on the changed estimated location at the time point.

That is, when information that an estimated location of the receiver is changed is received, the server 10 may determine a plurality of delivery plans again based on the changed estimated location, and determine one of the newly determined plurality of delivery plans as the final delivery plan, to update the final delivery plan.

For example, as shown in FIG. 7, since an estimated location of the receiver 10 minutes later is changed, when a first delivery plan that has the estimated location of the receiver 10 minutes later as a destination is a delivery plan having a minimum delivery time, the server 10 may update the final delivery plan as the first delivery plan.

Also, according to embodiments, when it is determined that circumstances of a deliverer that performs a delivery in the final delivery plan are changed based on state information received from the deliverer's terminal 40, the server 10 may update the final delivery plan based on the changed circumstances of the deliverer. The circumstances of the deliverer may be changes in traffic condition and weather condition, or abnormal states of deliverer (e.g., fuel shortage, abnormal health condition of the deliverer, and accident, etc.).

That is, when information that the circumstances of the deliverer are changed is received, the server 10 may determine a plurality of delivery plans again based on the changed circumstances, and determine one of the newly determined plurality of delivery plans as the final delivery plan, to update the final delivery plan.

For example, as shown in FIG. 8, in a state where a second delivery plan is provided as a final delivery plan, when it is determined that traffic conditions between a location of a deliverer 2 and an estimated location of the receiver 20 minutes later (section 3) are changed based on state information received from the terminal 40 of the deliverer 2, the server 10 may determine, as the final delivery plan, a fourth delivery plan in which the deliverer 2 moves to an estimated location of the receiver 25 minutes later, which takes shorter time, instead of the second delivery plan in which the deliverer 2 moves to an estimated location of the receiver 20 minutes later, thereby updating the final delivery plan as the fourth delivery plan.

Hereinafter, an embodiment of a control method of the server 10 according to an aspect of the disclosure is described. The server 10 described above may be used in the control method of the server 10. Accordingly, the above description with reference to FIGS. 1 to 8 may be equally applied to the control method of the server 10.

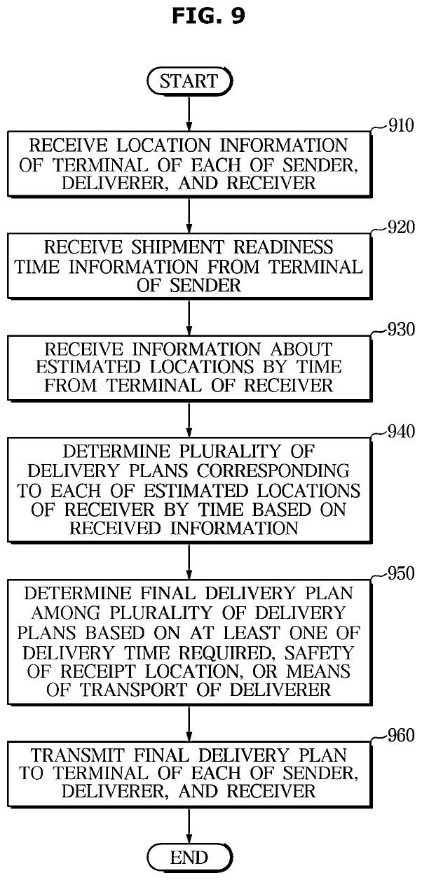

FIG. 9 is a flowchart illustrating operations of determining a final delivery plan in a control method of the server 10 according to an embodiment.

Referring to FIG. 9, according to an embodiment, the server 10 may receive location information from the terminals 20, 30 and 40 of each of the sender, the deliverer and the receiver (910).

According to an embodiment, the server 10 may receive shipment readiness time information from the sender's terminal 30 (920), and receive information about estimated locations at respective time points from the receiver's terminal 20 (930).

In this instance, the information about estimated locations at respective time points corresponds to information obtained by determining the estimated locations at multiple time points in a situation where the receiver is moving and converting it into data, and may indicate estimated locations at multiple time points from an initial time point (e.g., an estimated location 10 minutes later, an estimated location 20 minutes later, an estimated location 25 minutes later, etc.).

According to an embodiment, the server 10 may determine a plurality of delivery plans corresponding to the estimated locations of the receiver at respective time points based on the received information (940).

That is, the server 10 may determine the plurality of delivery plans corresponding to the estimated locations of the receiver at respective the time points, based on location information received from each of the receiver's terminal 20, the sender's terminal 30, and the deliverer's terminal 40, shipment readiness time information received from the sender's terminal 30, and information about the estimated locations at respective the time points received from the receiver's terminal 40.

In this instance, each of the plurality of delivery plans may include information about a delivery route between a location of the sender and a corresponding estimated location of the receiver and information about a deliverer who will perform delivery for each section included in the delivery route.

According to an embodiment, the server 10 may determine a final delivery plan among the plurality of delivery plans, based on at least one of a delivery time required, a safety of a receipt location, or means of transport of the deliverer (950). Also, the server 10 may transmit the final delivery plan to each of the receiver's terminal 20, the sender's terminal 30, and the deliverer's terminal 40 (960).

For example, the server 10 may determine a delivery plan having a minimum delivery time among the plurality of delivery plans, as the final delivery plan.

Also, the server 10 may determine a delivery plan having an expected receipt location with a highest safety as the receipt location among the estimated locations of the receiver at the respective the time points, among the plurality of delivery plans, as the final delivery plan.

In addition, the server 10 may determine a delivery plan having a deliverer who uses a preferred means of transport as the deliverer to perform the delivery, based on information about the preferred means of transport received from the receiver's terminal 20, among the plurality of delivery plans, as the final delivery plan.

Further, according to an embodiment, the server 10 may adaptively update the final delivery plan after determining the final delivery plan.

For instance, when information about a changed estimated location at a time point is received from the receiver's terminal 20, the server 10 may update the final delivery plan based on the changed estimated location of the receiver at the time point.

Also, when it is determined that circumstances of a deliverer that performs the delivery in the final delivery plan are changed based on state information received from the deliverer's terminal 40, the server 10 may update the final delivery plan based on the changed circumstances of the deliverer.

As is apparent from the above, according to the embodiments of the disclosure, when a location of a receiver changes with time, the server and the control method thereof can determine an optimized delivery plan including an optimal delivery route and optimal deliverer considering locations of the receiver, sender, and deliverer, thereby providing a flexible, efficient and user-friendly delivery system.

Embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include read only memory (ROM), random access memory (RAM), magnetic tapes, magnetic disks, flash memories, and optical recording medium.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A server that determines a delivery route of a package, the server comprising:
a communicator configured to perform communication with a terminal of each of a sender, a deliverer and a receiver; and
a controller configured to:
determine a plurality of delivery plans corresponding to estimated locations of the receiver at respective time points, based on location information received from the terminal of each of the sender, the deliverer and the receiver, shipment readiness time information received from the terminal of the sender, and information about the estimated locations at the respective time points received from the terminal of the receiver,
determine a final delivery plan among the plurality of delivery plans based on at least one of a delivery time required, a safety of a receipt location, or means of transport of the deliverer, and
control the communicator to transmit the final delivery plan to the terminal of each of the sender, the deliverer and the receiver,
wherein each of the plurality of delivery plans comprises information about a delivery route between a location of the sender and a corresponding estimated location of the receiver and information about a deliverer who performs a delivery for each section among a plurality of sections included in the delivery route.

2. The server of claim 1, wherein the controller is configured to determine a delivery plan having a minimum delivery time among the plurality of delivery plans, as the final delivery plan.

3. The server of claim 1, wherein the controller is configured to determine a delivery plan, among the plurality of delivery plans, having an expected receipt location with a highest safety as the receipt location among the estimated locations of the receiver at the respective time points, as the final delivery plan.

4. The server of claim 1, wherein the controller is configured to determine a delivery plan, among the plurality of delivery plans, having a deliverer who uses a preferred means of transport as the deliverer to perform the delivery, based on information about the preferred means of transport received from the terminal of the receiver, as the final delivery plan.

5. The server of claim 1, wherein, when information about a changed estimated location at a time point is received from the terminal of the receiver, the controller is configured to update the final delivery plan based on the changed estimated location of the receiver at the time point.

6. The server of claim 1, wherein, when it is determined that circumstances of a deliverer to perform the delivery in the final delivery plan are changed based on state information received from the terminal of the deliverer, the controller is configured to update the final delivery plan based on the changed circumstances of the deliverer.

7. The server of claim 1, wherein the controller is configured to determine the plurality of delivery plans by determining a deliverer to perform a delivery plan, based on at least one evaluation item of a degree of freedom from traffic conditions, a preference, a degree of freedom from weather conditions, a delivery success rate according to characteristics of the package, whether manned or unmanned, ease of delivery, a delivery cost, a total delivery time, or a preferred means of transport of the receiver.

8. The server of claim 7, wherein the controller is configured to determine an evaluation score for each deliverer by summing up scores of each of the at least one evaluation item, and determine a deliverer having a highest evaluation score as the deliverer to perform the delivery plan.

9. A control method of a server comprising a communicator, the control method comprising:
determining a plurality of delivery plans corresponding to estimated locations of a receiver at respective time points, based on location information received from a terminal of each of a sender, a deliverer and the receiver, shipment readiness time information received from the terminal of the sender, and information about the estimated locations at the respective time points received from the terminal of the receiver;
determining a final delivery plan among the plurality of delivery plans based on at least one of a delivery time required, a safety of a receipt location, or means of transport of the deliverer; and
controlling the communicator to transmit the final delivery plan to the terminal of each of the sender, the deliverer and the receiver,
wherein each of the plurality of delivery plans comprises information about a delivery route between a location of the sender and a corresponding estimated location of the receiver and information about a deliverer who performs a delivery for each section among a plurality of sections included in the delivery route.

10. The control method of claim 9, wherein the determining of the final delivery plan comprises determining a delivery plan having a minimum delivery time among the plurality of delivery plans, as the final delivery plan.

11. The control method of claim 9, wherein the determining of the final delivery plan comprises determining a delivery plan, among the plurality of delivery plans, having an expected receipt location with a highest safety as the receipt location among the estimated locations of the receiver at the respective time points, as the final delivery plan.

12. The control method of claim 9, wherein the determining of the final delivery plan comprises determining a delivery plan, among the plurality of delivery plans, having a deliverer who uses a preferred means of transport as the deliverer to perform the delivery, based on information about the preferred means of transport received from the terminal of the receiver, as the final delivery plan.

13. The control method of claim 9, further comprising:
when information about a changed estimated location at a time point is received from the terminal of the receiver, updating the final delivery plan based on the changed estimated location of the receiver at the time point.

14. The control method of claim 9, further comprising:
when it is determined that circumstances of a deliverer to perform the delivery in the final delivery plan are changed based on state information received from the terminal of the deliverer, updating the final delivery plan based on the changed circumstances of the deliverer.

15. The control method of claim 9, wherein the determining of the plurality of delivery plans comprises determining the plurality of delivery plans by determining a deliverer to perform a delivery plan, based on at least one evaluation item of a degree of freedom from traffic conditions, a preference, a degree of freedom from weather conditions, a delivery success rate according to characteristics of a package, whether manned or unmanned, ease of delivery, a delivery cost, a total delivery time, or a preferred means of transport of the receiver.

16. The control method of claim 15, wherein the determining of the plurality of delivery plans comprises determining an evaluation score for each deliverer by summing up scores of each of the at least one evaluation item, and determining a deliverer having a highest evaluation score as the deliverer to perform the delivery plan.
